(19) United States
(12) Patent Application Publication
(10) Pub. No.: US 2020/0260763 A1
(43) Pub. Date: Aug. 20, 2020

(54) A MICROWAVE OVEN WITH DRYING FUNCTION

(71) Applicant: ARCELIK ANONIM SIRKETI, Istanbul (TR)

(72) Inventors: Sezgi YIKILMAZCINAR, Istanbul (TR); Metin GUR, Istanbul (TR); Merve GUVEN, Istanbul (TR); Serdal ELMAS, Istanbul (TR); Haluk KARATAS, Istanbul (TR)

(21) Appl. No.: 16/066,217

(22) PCT Filed: Nov. 30, 2016
(86) PCT No.: PCT/EP2016/079265

§ 371 Date: Jun. 26, 2018

(30) Foreign Application Priority Data
Dec. 29, 2015 (TR) 2015/17196

(51) Int. Cl. A23L 3/54; H05B 6/72; H05B 6/64; H05B 6/80; F26B 3/347; F26B 9/06; F26B 25/18; A23B 7/02

(52) U.S. Cl. CPC A23L 3/54; H05B 6/72; H05B 6/6408; H05B 6/80; A23V 2002/00; F26B 9/066; F26B 25/18; A23B 7/02; H05B 2206/046; F26B 3/347

(57) ABSTRACT

The present invention relates to a microwave oven comprising a microwave generator, a control unit that controls the microwave generator, a lower tray and an upper tray that are produced from a microwave permeable material, whereon the foodstuffs to be dried are placed and that are placed one on top of another so that a gap remains therebetween, and a cavity wherein the lower tray and the upper tray are placed.

The present invention relates to a microwave oven wherein foodstuffs, especially such as fruits and vegetables, are dried.

In order to dry various foodstuffs, especially vegetables and fruits, in a microwave oven, specially formed drying trays are used. In the microwave ovens, the density of the electromagnetic field acting on the central part of the drying tray is higher than the edges of the tray. The foodstuffs placed in the center of the drying tray where the microwave density is higher dry quicker, while a longer period is needed on the edges and corners where the microwave density is lower. When drying of the foodstuffs placed on the edges and corners is completed, the foodstuffs in the center are observed to have burnt. In the state of the art embodiments, the central part of the tray where the density of the electromagnetic field is high is left empty.

In the state of the art Great Britain Patent Application No. GB2236646, a microwave oven comprising a tray whereon kitchen utensils are placed and dried is disclosed.

The aim of the present invention is the realization of a microwave oven wherein the foodstuffs are enabled to be homogenously dried.

The microwave oven realized in order to attain the aim of the present invention, explicated in the first claim and the respective claims thereof, comprises two trays that are produced from a microwave permeable material and that are placed one on top of another, an aperture that is arranged in the center of the upper tray and a guide that is placed into the said aperture and that passes through the aperture, extending from the upper tray to the lower tray. Thus, dense microwaves coming onto the central part of the upper tray are dissipated by means of the guide and transmitted to the lower tray, providing a homogenous food drying process.

In an embodiment of the present invention, the guide is a hollow conic pipe. The inlet port of the guide remaining above the upper tray is narrower than the inlet port facing the lower tray. The side wall of the guide has preferably a concave curved form. Thus, the microwaves are enabled to be homogenously dissipated to almost all regions of the lower tray.

In other embodiments of the present invention, the guide has the form of a quadrangular or a triangular pyramid which widens from top to bottom.

In another embodiment of the present invention, a microwave stirrer is placed into the guide so as to provide a more efficient homogenous distribution.

A microwave oven realized in order to attain the aim of the present invention is illustrated in the attached figures, where:

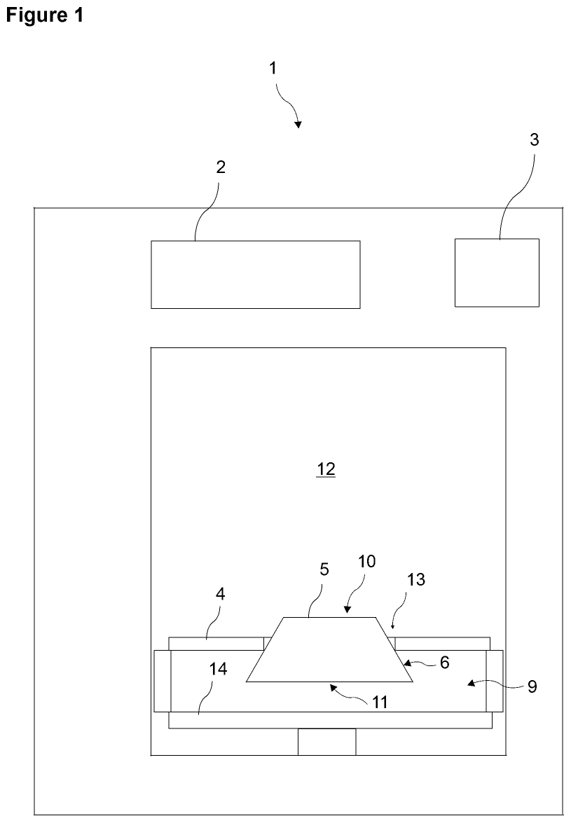

FIG. 1—is the schematic view of the microwave oven of the present invention.

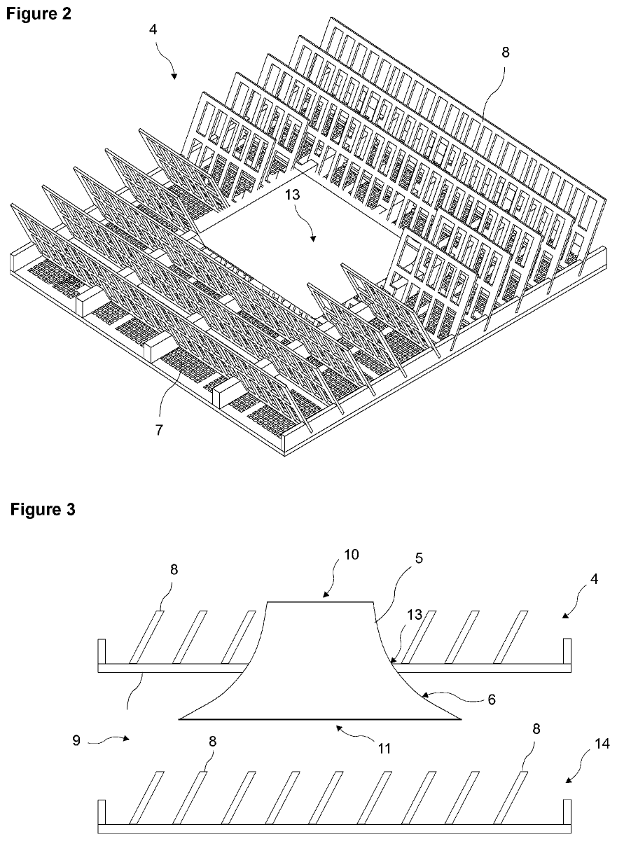

FIG. 2—is the perspective view of an upper tray.

FIG. 3—is the schematic view of two trays positioned one on top of another, and of a guide.

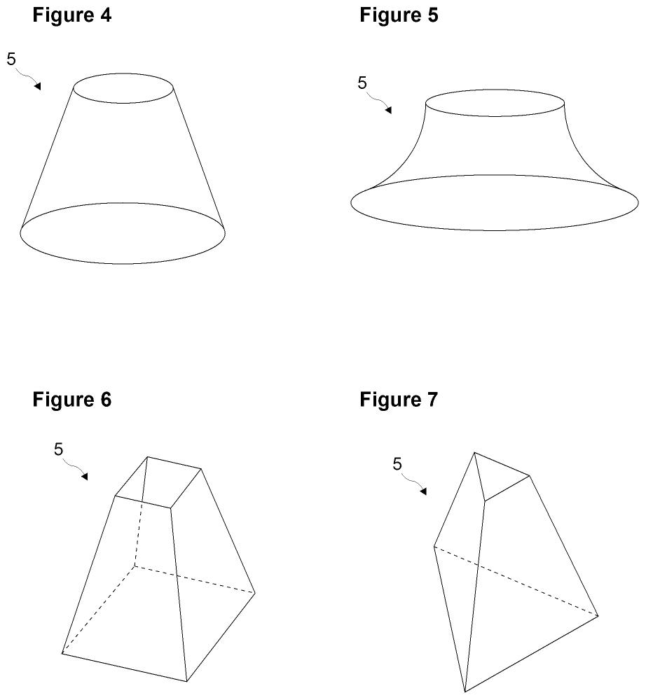

FIG. 4—is the schematic view of a frustoconical guide.

FIG. 5—is the schematic view of a guide with a concave curved side wall.

FIG. 6—is the schematic view of a guide in quadrangular pyramid form.

FIG. 7—is the schematic view of a guide in triangular pyramid form.

The elements illustrated in the figures are numbered as follows:
1. Microwave oven
2. Microwave generator
3. Control unit
4. Upper tray
5. Guide
6. Side wall
7. Hole
8. Support
9. Gap
10. Inlet port
11. Outlet port
12. Cavity
13. Aperture
14. Lower tray

Microwave oven (1) comprises a microwave generator (2), a control unit (3) that controls the microwave generator (2), a lower tray (14) and an upper tray (4) that are produced from a microwave permeable material, whereon the foodstuffs to be dried are placed and that are placed one on top of another so that a gap (9) remains therebetween, and a cavity (12) wherein the lower tray (14) and the upper tray (4) are placed.

The microwave oven (1) of the present invention comprises an aperture (13) that is arranged in the center of the upper tray (4), and a guide (5) that is placed into the aperture (13), that passes through the gap (9) and that extends from the upper tray (4) to the lower tray (14) (FIG. 1 and FIG. 3).

In the microwave (1) of the present invention, the guide (5) is placed into the aperture (13) at the base of the upper tray (4). The dense microwaves coming onto the central section of the upper tray (4) pass through the guide (5) and diffuse over the lower tray (14). The microwaves that come to the edge regions of the upper tray (4) and have lower density pass through the upper tray (4) and directly act on the lower tray (14).

The guide (5) comprises an inlet port (10) that is disposed on the upper tray (4) and through which the electromagnetic waves emanating from the microwave generator (2) enter the guide (5), an outlet port (11) that opens to the gap (9) between the lower tray (14) and the upper tray (4) and that faces the lower tray (14), and a side wall (6) that is disposed between the inlet port (10) and the outlet port (11) and that guides the microwaves. The side wall (6) of the guide (5) and the shape of the aperture (13) are in matching form so that the guide (5) is seated into the aperture (13) without any gap. Thus, any microwave leakage from between the side wall (6) and the aperture (13) is prevented. The guide (5) is preferably produced from metal.

The upper and lower trays (4 and 14) also comprise holes (7) in such size to allow the passage of the electromagnetic energy and one or more than one support (8) that enables the foodstuffs placed thereon to be kept in an orderly manner.

The foods to be dried are placed into the upper and lower trays (4 and 14) and placed into the microwave oven (1). The microwave generator (2) operated by the control unit (3) provides the dissipation of the electromagnetic energy into the cavity (12). The microwaves coming onto the upper tray (4) in the central section where the density of the electromagnetic energy is high are received into the guide (5) through the inlet port (10) and leave the guide (5) through the outlet port (11) opening to the gap (9) between the upper tray (4) and the lower tray (14) and are directed to the lower tray (14). The microwaves that come onto the edge sections of the upper tray (4) and do not enter the guide (5) pass directly through the holes (7) and reach the lower tray (14).

In an embodiment of the present invention, the width of the outlet port (11) of the guide (5) is greater than the width of the inlet port (10). Thus, the electromagnetic energy reaching the gap (9) between the lower tray (14) and the upper tray (4) by means of the guide (5) is enabled to be homogeneously diffused over the lower tray (14).

In another embodiment of the present invention, the guide (5) is in frustoconical form and has preferably the side wall (6) in concave curved form (FIG. 4, FIG. 5). In this embodiment, the aperture (13) is in circular form.

In another embodiment of the present invention, the guide (5) is in the form of a truncated quadrangular pyramid and the aperture (13) is in quadrangular form (FIG. 6). In another embodiment of the present invention, the guide (5) is in the form of a truncated triangular pyramid and the aperture (13) is in triangular form (FIG. 7).

By means of the present invention, in a microwave oven (1) wherein a lower tray (14) and an upper tray (4) are used, in the cases that the density of the electromagnetic energy is higher in comparison with the edges, the dense microwaves are passed by means of a guide (5) through the center of the upper tray (4) and dissipate all over the surface of the lower tray (14), thus providing a homogenous and quick drying process.

1. A microwave oven comprising a microwave generator, a control unit that controls the microwave generator, a lower tray and an upper tray that are produced from a microwave permeable material, whereon the foodstuffs to be dried are placed and that are placed one on top of another so that a gap remains therebetween, and a cavity wherein the lower tray and the upper tray are placed, characterized by an aperture that is arranged in the center of the upper tray, and a guide that is placed into the aperture, that passes through the gap and that extends from the upper tray to the lower tray.

2. The microwave oven as in claim 1, characterized by the guide comprising an inlet port that is disposed on the upper tray and through which the microwaves emanating from the microwave generator enter the guide, an outlet port that opens to the gap between the lower tray and the upper tray and that faces the lower tray, and a side wall that is disposed between the inlet port and the outlet port and that guides the microwaves.

3. The microwave oven as in claim 1, characterized by the guide of which the outlet port is wider than the inlet port.

4. The microwave oven as in claim 3, characterized by the guide in frustoconical form.

5. The microwave oven as in claim 3, characterized by the guide which has the side wall in concave curved form.

6. The microwave oven as in claim 4, characterized by the aperture in circular form.

7. The microwave oven as in claim 3, characterized by the guide in the form of a truncated quadrangular pyramid and the aperture in quadrangular form.

8. The microwave oven as in claim 3, characterized by the guide in the form of a truncated triangular pyramid and the aperture in triangular form.

9. The microwave oven as in claim 1, characterized by the guide that is produced from metal.

10. The microwave oven as in claim 1, characterized by the upper and lower trays comprising holes in such size to allow the passage of electromagnetic energy and one or more than one support that enables the foodstuffs placed thereon to be kept in an orderly manner.
